(19) United States
(12) Patent Application Publication
(10) Pub. No.: US 2011/0258091 A1
(43) Pub. Date: Oct. 20, 2011

(54) METHOD AND SYSTEM FOR PROCESSING ACCOUNTING INFORMATION

(76) Inventors: John Geoffrey Wilson, Forest Hill (AU); Michael Anthony Both, Cheltenham (AU)

(21) Appl. No.: 13/129,322

(22) PCT Filed: Nov. 13, 2009
(86) PCT No.: PCT/AU2009/001475

§ 371 Date: Jun. 24, 2011

(30) Foreign Application Priority Data
Nov. 14, 2008 (AU) 2008905911

(51) Int. Cl. G06Q 40/00

(52) U.S. Cl. 705/30

(57) ABSTRACT

A computer-implemented system and method for generating a uniform statement of financial information from input financial data records each having a record description and an input financial value, that involve providing an accounting standard (208) having standard terms that are associated with standard types; a ruleset (206) that is associated with the input financial data records which ruleset (206) includes rules wherein each rules includes a description and an associated mapping to one of the standard terms of the standard (208); generating for each input financial data record, a plurality of output financial data records by determining (204) a best-match rule for the record amongst the rules in the ruleset (206) wherein each of the output financial data records includes a standard description and an output financial value; and compiling (214) the said uniform statement of financial information.

### FIELD OF THE INVENTION

The present invention relates to automated information and data processing, and more particularly to the transformation of financial data between disparate formats employed by different software applications, end-users and institutions.

### BACKGROUND OF THE INVENTION

Financial transactions, including personal and business transactions, are commonly recorded, managed and processed using software accounting packages. Popular personal and business financial management software includes products such as MYOB™, Quicken™, Sage™, and Microsoft™ Dynamics#. Such software packages are used by individuals, by businesses, and by accountants, to manage the personal and business financial matters of themselves and/or their clients.

Within most financial management software packages, users are able to use non-unique terminology to describe assets, liabilities, equity, income statement entries, and the like. As a result, it is unlikely that any two users of a particular software package will utilise exactly the same terminology to describe the same types of financial transactions or records. In general, the terminology used by a particular user reflects their own perception of the corresponding transactions or records, and their desire to easily identify and recall the meaning and origin of a particular entry.

At the same time, financial institutions, such as banks, utilise financial analysis software, for example to assist with the determination of whether an existing or new borrower is able to service or repay all lending commitments. For example, such software is used to determine whether or not to approve a new application for a loan, or line-of-credit, or to determine the maximum amount that a financial institution may be willing to lend a particular borrower. The data required by the financial analysis software is generally available within the records of accounts maintained by the prospective borrower. However, the terminology and entry types utilised by financial analysis software packages generally differs from the terminology utilised in popular accounting and financial management software, particularly given the ability for users of such software to employ their own terminology to describe accounting entries.

Even the existence of “standard” terminology, such as that detailed in the Australian Accountancy Standards (AAS), only partially addresses the problem of translating entries between different software packages. For example, the term “trade receivables” in the AAS corresponds commonly with the term “trade debtors” in MYOB™, and with the term “accounts receivable—trade” in the Moody's Financial Analysis software employed by some major financial institutions. Such terminology is sufficiently similar in meaning for skilled operators, such as accountants and bankers, to distinguish and match corresponding entries, notwithstanding the variations and differences. However, the very wide range of potential variation in terminologies has hitherto prevented the automation of transfer of financial data between financial software packages, such as between individual and business financial management software, and the financial analysis software used by major financial institutions.

Accordingly, financial institutions, such as banks, presently employ human operators to manually translate and enter data from a customer's balance sheet, profit and loss and cash flow forecast, into the institution's financial analysis software.

The reliance upon manual entry results in a real economic cost to the financial institutions, namely the cost of employment of the human operators. Furthermore, the need for manual entry limits the turnaround time, ie the speed with which a financial institution is able to process and approve (or deny) an application for credit. It would therefore be highly desirable to provide for a greater degree of automation in the translation of financial data between disparate formats employed by different software applications, in order to reduce the reliance upon human operators.

### SUMMARY OF THE INVENTION

In a first aspect, the present invention provides a computer-implemented method of generating a uniform statement of financial information from a plurality of input financial data records, wherein each input financial data record includes at least a record description and an input financial value, the method including the steps of:
providing an accounting standard which includes a plurality of predetermined standard terms, each of which is associated with one of a plurality of predetermined standard types;
providing at least one ruleset associated with the input financial records, the ruleset including a plurality of rules, wherein each rule includes at least a rule description, and an associated mapping to one of the standard terms of the accounting standard;
generating a plurality of output financial data records by, for each one of said input financial data records:
   determining a best-match rule for the financial data record amongst the rules in the ruleset, by comparing at least the record description with the rule descriptions of rules within the ruleset; and
   generating an output financial data record including a standard description corresponding with the standard term associated with the best-match rule, and an output financial value corresponding with the input financial value,
and compiling a uniform statement of financial information including said plurality of output financial data records.

Advantageously, therefore, the ruleset is able to provide a flexible mapping between terminology used in the input financial data records and terminology used in the accounting standard.

More particularly, the provision of additional rules within the ruleset advantageously enables a wider range of input terminology to be mapped to specific standardised terms. Furthermore, embodiments of the invention do not necessarily require an exact match between an input record description and a rule description within the ruleset, but rather are able to base the selection of relevant standard terminology upon the determination of a best match between the input record description and rule descriptions within the ruleset. As will be apparent from the detailed description of a preferred embodiment, which follows this summary of the invention, the combination of these features enables extremely powerful and flexible transformation of input financial data records into corresponding output financial data records having standardised descriptions and types.

It should be appreciated that the “accounting standard” provided in accordance with embodiments of the invention need not be a recognised or established standard, such as the AAS, although this is certainly one option. In practice, any set of predetermined terms and types sufficient to provide a mapping for all relevant input financial data records, will suffice.

Preferably, each input financial data record includes an associated input record type, and each rule in the ruleset further includes a corresponding type indication, whereby the step of determining a best-match rule includes comparing the record description with the rule description only of rules in the ruleset for which the type indication is compatible with the input record type. Whereas financial management software packages generally allow the user to customise the description for each record or entry, they also generally require (or enable) the user to associate the entry with a particular type, such as “asset”, “liability”, “equity”, “income”, “expenses”, and so forth. The association of a specific type with a transaction or other entry limits the potential meaning, or classification, of the input record, and it is accordingly advantageous to limit the matching within the ruleset to only those rules associated with a compatible type indication.

Preferably, therefore, the ruleset corresponds with a source software application used to record, maintain and/or generate the input financial data records. That is, embodiments of the invention advantageously provide specific rulesets corresponding with common financial management software packages, such as MYOB™, Quicken™, Sage™, Microsoft™ Dynamics™ and so forth, wherein the rules in each such ruleset include type indications corresponding with the set of types supported by the particular software application. Thus, for example, when processing input financial data records exported from MYOB™, a specific MYOB™ ruleset may be utilised.

The step of determining a best-match rule amongst the rules in the ruleset advantageously includes pre-processing the record description to facilitate comparison with rule descriptions in the ruleset. Pre-processing may be particularly useful, for example, to allow for the occurrence of common or obvious variants of individual words or phrases within descriptive terms, so as to avoid the need for excessively large rulesets.

In a particularly preferred embodiment, pre-processing includes substitution of terms appearing within the record description. A substitution table may be used, for example, to convert common variants of a word, such as “depreciation”, into a single “primary” term. Advantageously, the ruleset may then exclusively utilise the primary terms, relying upon the pre-processing step to perform any relevant conversion from equivalent variants (ie “substitute” terms). Common substitutes may include plurals, misspellings, abbreviations, and so forth.

As will be appreciated, certain terms, and abbreviations in particular, may be ambiguous. For example, the abbreviation “ACC” may stand either for “account” if used in the context of a bank, or “accumulated” if used in the context of depreciation. Advantageously, therefore, embodiments of the invention perform disambiguation of such terms by use of context-sensitive substitution, whereby the choice of an appropriate primary term is based upon other elements of the input financial data record, such as words or phrases appearing in the record description.

In some cases, the best match may be a direct match between the record description (pre-processed if applicable) and a rule within the ruleset. If no direct match exists, then a number of candidate matches may be generated and ranked, in accordance with an appropriate ranking algorithm. As will be appreciated, various algorithms for assessing a “closeness” of match between text strings are available, such as the Levenshtein Edit Distance, and the selection and implementation of a suitable measure for ranking of results is largely a matter of design choice.

Advantageously, the step of compiling a uniform statement of financial information includes grouping the output financial data records in accordance with associated standard types within the accounting standard. Data may also be compiled over multiple years of financial records. Additionally, totals and/or summaries of financial information may be generated, and/or additional ratios or other metrics calculated, in accordance with a required format of the uniform statement of financial information.

In particularly preferred embodiments of the invention, the format of the uniform statement of financial information corresponds with a required format of a destination financial software package, such as a financial analysis software package utilised by a financial institution for the purpose of processing credit applications and the like. Advantageously, embodiments of the invention may support a number of different uniform statement formats, such that multiple different output formats may be supported, for example satisfying the requirements of financial analysis software utilised by different financial institutions.

In another aspect, the present invention provides a computer-implemented apparatus for generating a uniform statement of financial information from a plurality of input financial data records, wherein each input financial data record includes at least a record description and an associated input financial value, the apparatus including:
a data store containing an accounting standard which includes a plurality of predetermined standard terms, each of which is associated with one of a plurality of predetermined standard types;
a data store containing at least one ruleset associated with the input financial records, the ruleset including a plurality of rules, wherein each rule includes at least a rule description, and an associated mapping to one of the standard terms of the accounting standard;
computer-software-implemented means for generating a plurality of output financial data records by, for each one of said input financial data records, providing computer-software-implemented means for:
   determining a best-match rule for the financial data record amongst the rules in the ruleset by comparing at least the record description with the rule descriptions of rules within the ruleset; and
   generating an output financial data record including a standard description corresponding with the standard term associated with the best-match rule, and an output financial value corresponding with the input financial value,
computer-software-implemented means for compiling a uniform statement of financial information including said plurality of output financial data records; and
computer-software-implemented means for outputting the uniform statement of financial information.

In preferred embodiments, the apparatus includes at least one input/output peripheral interface arranged to receive the input data records and to output the uniform statement of financial information. The input/output peripheral interface may include an interface to an internal or external data storage device, such as a hard-disk drive, removable memory device (eg USB memory stick), and/or a removable media drive (eg a CD-ROM or DVD-ROM drive).

In a particularly preferred embodiment, the input/output peripheral interface includes a network interface. The apparatus may include an Internet server, implemented via appropriate software components, such that input data records may be received, and the uniform statement of financial information output, via the Internet. Preferably, the apparatus is arranged so as to provide a secure web-based service.

The apparatus preferably includes:
a microprocessor;
at least one memory device, operatively coupled to the microprocessor; and
at least one input/output peripheral interface, operatively coupled to the microprocessor,
wherein the memory device includes the data stores containing the accounting standard and the at least one ruleset, and
wherein the memory device further contains executable instruction code, which, when executed by the microprocessor, implements a method embodying the first aspect of the invention.

Further preferred features and advantages of the present invention will be apparent to those skilled in the art from the following description of a preferred embodiment of the invention, which should not be considered to be limiting of the scope of the invention as defined in any of the preceding statements, or in the claims appended hereto.

### BRIEF DESCRIPTION OF THE DRAWINGS

A preferred embodiment of the invention is described with reference to the accompanying drawings, in which like reference numerals refer to like features, and wherein:

FIG. 1 is a block diagram illustrating a system for transforming financial data, including an apparatus for generating a uniform statement of financial information, according to an embodiment of the invention;

FIG. 2 is a flowchart illustrating a method of generating a uniform statement of financial information according to an embodiment of the invention;

FIG. 3 illustrates schematically data transformation within a method of generating a uniform statement of financial information, according to an embodiment of the invention;

FIG. 4 is a flowchart illustrating preferred steps in determining a best-match rule for a financial data record;

FIG. 5 is a first example illustrating a determination of best match;

FIG. 6 shows an exemplary excerpt from a substitution table;

FIG. 7 is a second example illustrating a determination of best match;

FIG. 8 is a third example illustrating a determination of best match;

FIG. 9 is a fourth example illustrating a determination of best match, including negative reallocation;

FIG. 10 is a fifth example illustrating a determination of best match, wherein a direct match exists; and

FIG. 11 is an example illustrating the handling of a case in which no match is found.

### DETAILED DESCRIPTION OF A PREFERRED EMBODIMENT

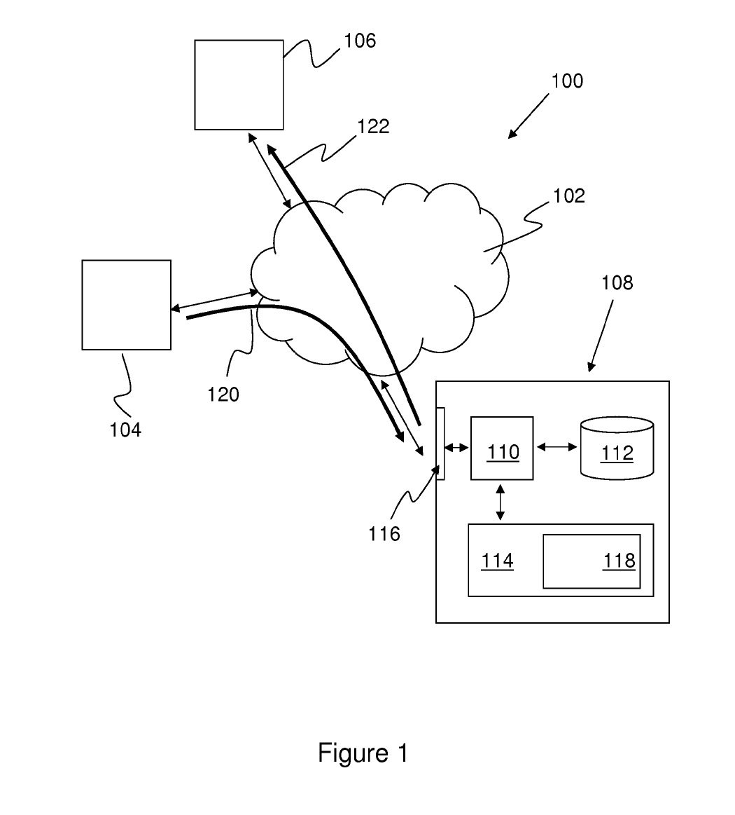

FIG. 1 illustrates schematically a network-based system 100 embodying the present invention. In the exemplary embodiment, the system 100 is interconnected via the Internet 102. However, the exemplary system 100 should not be considered to be limiting, since embodiments of the invention may be deployed via alternative data networks, such as private financial transaction networks, or implemented in a “standalone” form, wherein data is entered and retrieved via alternative means, such as storage media including hard-disk drives, removable memory devices, and/or removable media such as CD-ROM or DVD-ROM discs. Deployment via the Internet is considered to be particularly advantageous, since it enables the benefits of the invention to be delivered remotely to a relatively large number of end-users.

The system 100 includes a user computer 104, which may be a computer of an end-customer, or of an accountant providing accountancy services to a client. Accountancy or financial management software, such as MYOB™ Quicken™, Sage™, Microsoft™ Dynamics™, or the like, is installed and executes on the user computer 104.

The exemplary system 100 further includes a financial institution computer 106, which is owned and/or operated by an institution such as a bank. The financial institution computer 106 has financial analysis software installed thereon, which is configured to analyse and process customer requests, such as applications for credit.

While the embodiment described herein illustrates a transformation between customer accounts maintained on the user computer 104, and the input data format required by the financial analysis software installed on the financial institution computer 106, it will be appreciated that the general framework provided by embodiments of the invention is applicable to transforming input financial data records from a variety of sources into a range of different uniform output statement formats. Accordingly, the invention is not limited to the particular examples disclosed herein.

For simplicity, components of the system 100 that are not required for the purposes of describing the preferred embodiment of the present invention have been omitted from FIG. 1. For example, it will be appreciated that various firewalls and/or other intermediate communications devices, which would be included in any practical implementation of the system 100, have been omitted from the drawing.

A server computer 108 is accessible to both the user computer 104 and the financial institution computer 106, via the Internet 102. The server computer 108 includes at least one processor 110, which is interfaced, or otherwise associated, with a high-capacity, non-volatile memory/storage device 112, such as one or more hard-disk drives. The storage device 112 is used primarily to contain programs and data required for the operation of the computer 108, and for the implementation and operation of various software components implementing an embodiment of the present invention. The means by which this may be achieved are well-known in the art, and accordingly will not be discussed in detail herein.

The server computer 108 further includes an additional storage medium 114, typically being a suitable type of volatile memory, such as random access memory, for containing program instructions and transient data relating to the operation of the computer 108. Additionally, the computer 108 includes a network interface 116, accessible to the central processor 110, facilitating communications via the Internet 102.

The memory device 114 contains a body of program instructions 118 embodying various software-implemented features of the present invention, as described in greater detail below with reference to the remaining drawings. In general, these features include data analysis and processing functions implementing a method of generating a uniform statement of financial information from a plurality of input financial data records. Additionally, a web server application is implemented, enabling the functions of the computer 108 to be accessed via the Internet 102 from the user computer 104 and/or the financial institution computer 106, via widely-available software applications, such as web browser software.

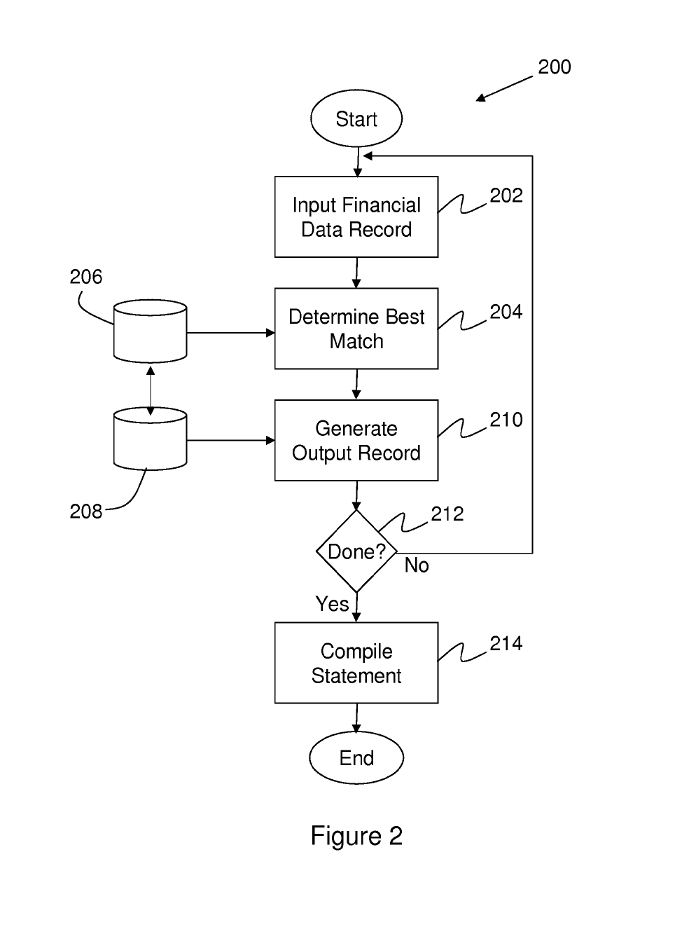

Turning now to FIG. 2, there is shown a flowchart 200 illustrating a method of generating a uniform statement of financial information from a plurality of input financial data records, in accordance with the preferred embodiment of the invention. At step 202, an input financial data record is received for processing. At step 204, a best match is determined for the input financial data record, within a ruleset 206. The ruleset is associated with the input financial data records and with an accounting standard 208. At step 210, an output financial data record is generated, based upon the best match identified in the ruleset 206, and a corresponding entry within the accounting standard 208. In accordance with the decision 212, if there are further input financial data records to be processed, control is returned to step 202. Otherwise, at step 214, a uniform statement of financial information is compiled.

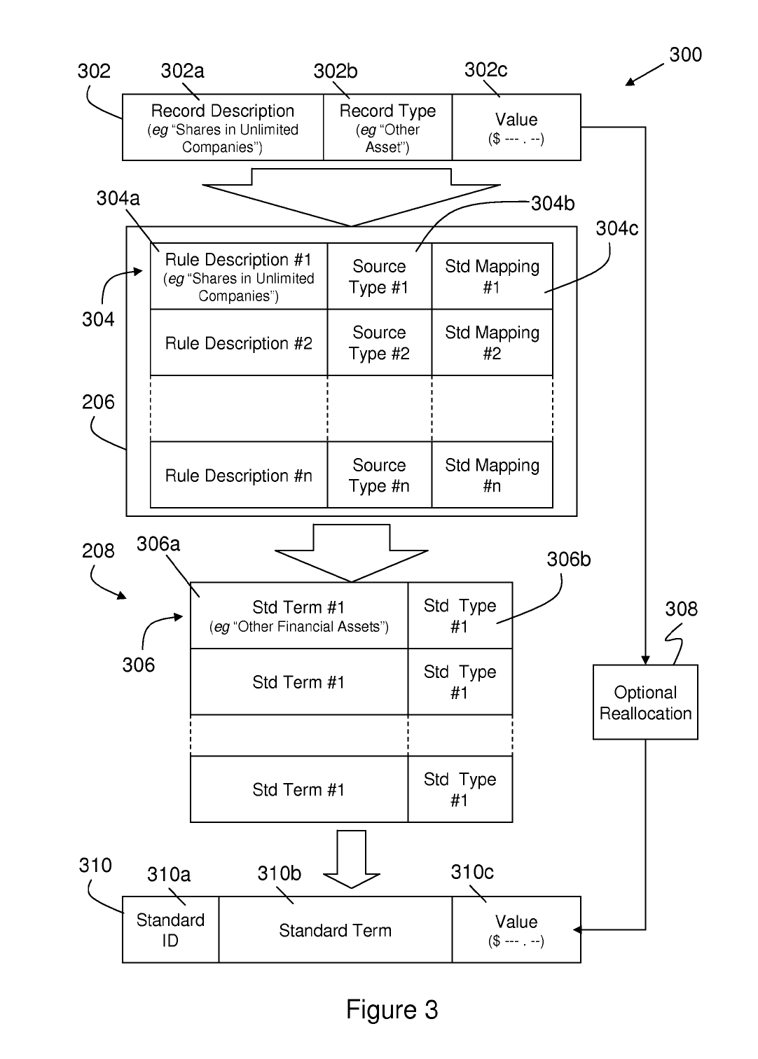

While the flowchart 200 illustrates the main steps within the exemplary method, further details of the format of input financial data records, the ruleset 206, the accounting standard 208, and the specific implementation of the various steps, are described below with reference to FIGS. 3 to 11.

FIG. 3 illustrates schematically a preferred schema for data transformation in accordance with the invention. In particular, the block diagram 300 illustrates an exemplary input financial data record 302, an exemplary ruleset 206, including a plurality of rules, eg 304, an exemplary accounting standard 208 including a plurality of entries, eg 306, and an exemplary output financial data record format 310. In a practical software implementation of the schema, the ruleset 206 and accounting standard 208 may be implemented, for example, as tables within a data store, such as an allocated region of volatile or non-volatile memory, or a database. The block diagram 300 also shows an optional reallocation function. The operation of the data transformation schema 300 will now be described in greater detail.

As illustrated, an input financial data record, such as may be exported from a financial management software package such as MYOB™, includes at least a record description 302a, and a corresponding financial value 302c. Preferably, and in accordance with the functionality of most widely available financial management packages, the input financial data record 302 also includes a record type 302b. By way of example, the record description 302a may be “Shares in Unlisted Companies”, having a record type 302b of “Other Asset”, and an associated financial value 302c, being a dollar amount.

A ruleset 306 includes a plurality of rules, eg 304, each of which includes at least a rule description 304a, and a standard mapping 304c. In the preferred embodiment, each rule 304 also includes an associated source type 304b. It is the objective, in step 204 of the method 200, to identify a rule within the ruleset 206 that is the best available match to the input financial data record 302. In order to do so, the record description 302a is compared with the rule description, eg 304a, of each rule, eg 304, within the ruleset 206. Preferably, the input financial data record 302 includes a record type 302b, and the rules each include a source type, eg 304b, whereby a comparison is only performed with rules having a source type that is compatible with the type of the input financial data record. In this way, confusion may be avoided between rules having similar rule descriptions, but incompatible source types. For example, an input financial data record corresponding with an asset can never be a “best match” for a rule relating to a liability. There need not, however, be a direct one-to-one correspondence between record types and source types, since for the purposes of data transformation some types may be treated as inherently compatible. For example, a financial management or accounting software package may allow the user to define entries as “assets”, or “other assets”, for the purpose of the user differentiating between different types of assets within a financial statement, however for accounting purposes it may be possible to treat both of these record types identically, as “assets”

The standard mapping 304c within each rule 304 identifies a specific entry, eg 306, within the accounting standard 208. For example if the record description “Shares in Unlisted Companies”, having a record type of “Other Asset”, matches a particular rule, eg 304, having an identical description 304a, then the standard mapping 304c identifies the corresponding relevant entry, eg 306, within the accounting standard 208. Each such entry includes a standard term, eg 306a, such as “Other Financial Assets” (which may be the appropriate standard for “Shares in Unlisted Companies”) and an associated standard type 306b which defines its standard accounting function.

The translation of the input financial data record 302 via matching with the ruleset 206, and through the accounting standard 208, enables an output financial data record 310 to be generated, in accordance with step 210 of the method illustrated by the flowchart 200. The exemplary output financial data record 310 includes a standard identifier 310a, corresponding with the entry number within the accounting standard 208, the associated standard term 310b, and the output financial value 310c. In a majority of cases, the output financial value 310c will be a dollar value that is identical with the input financial value 302c. However, in some cases it may be desirable to perform one or more processing operations on the input financial data value 302c, in order to derive the output financial value 310c. For these cases, an optional reallocation function 308 is provided. Reallocation may also involve a further mapping within the accounting standard 208, in order to generate the output financial data record 310. For simplicity this remapping function is not explicitly shown in the schema 300.

One particular example in which a remapping and reallocation may be performed is when the numerical sign of the input financial value 302c is found to be inconsistent with the ultimately determined type of the financial data record, within the accounting standard 208. For example, if an entry that is found to correspond with the standard term “cash” includes a negative financial value, then the output financial data record may be remapped and reallocated to use an appropriate alternative term, such as “bank overdraft”, in combination with a positive value. Other common examples of accounting transactions with a corresponding “negative reallocation” include: “debtor” and “creditor”; “expenses” and “other income”; “income” and “other expense”; and “shareholder loans payable—non-current” and “shareholder loans—non-current (non-current liabilities)”. The purpose of such reallocation is to ensure consistency of accounting, in accordance with the accounting standard 208, within the output financial data records 310.

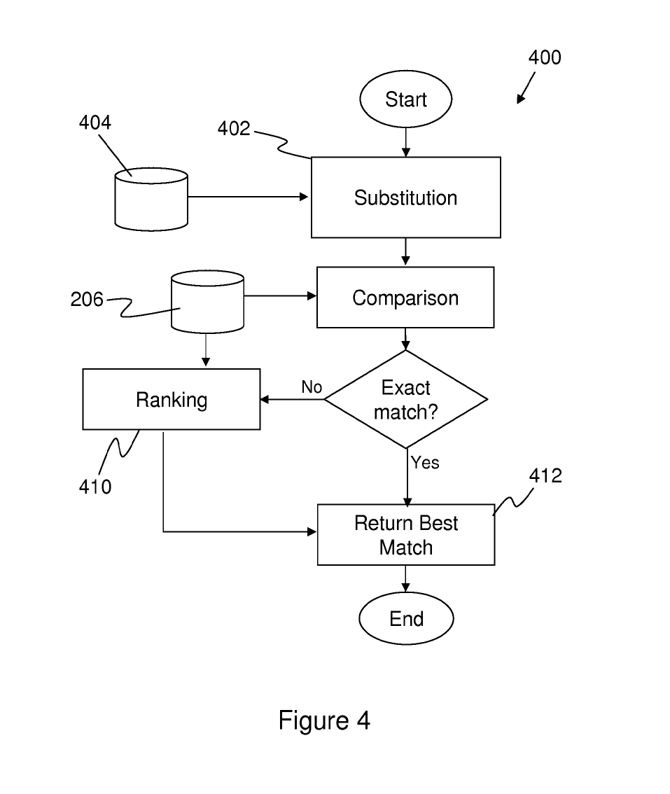

In the discussion of FIG. 3 above, very simple illustrative examples were provided in which a direct match exists between a record description 302a and a corresponding rule description 304a within the ruleset 206. If it were possible, in principle, to predict all possible descriptive terms that may be employed by the users of various financial management and/or accounting packages, the ruleset 206 could be populated with an exhaustive list of rules 304, mapping every single possible input description to a corresponding entry in the accounting standard 208. However, such an exhaustive enumeration of rules is not possible in practice. Since most financial management and accounting software packages enable users to create arbitrary record descriptions, it is, as a practical matter, impossible to predict all of the descriptions that may be encountered within input financial data records. Even if there were a sufficient degree of consistency and/or standardisation in descriptive terminology used by different users, the occurrence of spelling mistakes, typographical errors, abbreviations, and so forth, would result in some record descriptions failing to match any of the rules in the ruleset 206. Accordingly, embodiments of the present invention are not limited to direct matching between a record description and a rule description, but rather employ additional processing in order to impose greater uniformity upon common variations of terms, and to enable a “best match” to be found, in the event that no direct match exists within the ruleset 206. The general procedure for determining a best-match rule for a financial data record, according to the preferred embodiment of the invention, is illustrated in the flowchart shown in FIG. 4.

The preferred matching method includes a pre-processing step of substitution 402, followed by a comparison step 406, which allows for inexact matching between the pre-processed input financial data record and the rules within the ruleset 206.

The substitution step 402 utilises a substitution table 404 to identify “primary” and “substitute” terms appearing within the record description. In a practical implementation, the substitution table may be maintained in a suitable data store, such as an allocated region of volatile or non-volatile memory, or a database.

A primary term is the preferred word, in accordance with common accounting usage, and is generally defined to be singular. Examples of primary terms include “accumulated”, “building”, “interest”, and “depreciation”. For each primary term within the substitution table 404 there may be any number of substitute terms, which are considered to be equivalent in meaning to the primary term. Thus, for example, the abbreviation “dep'n” may be considered an equivalent substitute term for the primary term “depreciation”. Substitute terms may include any relevant variant of the primary term, including plurals, misspellings, abbreviations, typographical variations, and so forth. The substitution step 402 proceeds through the record description, on a term-by-term (ie word-by-word) basis, replacing any substitute terms identified with the corresponding primary term. Accordingly, the description output from the substitution step 402 is more “uniform” in terminology and the description in the input data record. This facilitates design of the ruleset, since it is possible then to make use of primary terms only within the rule descriptions, without including all of the variations covered by the substitute terms.

However, certain terms, and abbreviations in particular, may be ambiguous in the absence of suitable contextual information. For example, the abbreviation “ACC” may stand either for “account” if used in the context of a bank, or “accumulated” if used in the context of depreciation. This ambiguity may be handled by maintaining an additional list of potentially ambiguous terms, along with associated (primary) context terms that may be used to determine the appropriate meaning of each ambiguous term. This information may be maintained, for example, within a relational database. When an ambiguous term is encountered during substitution, other terms appearing within the record description are compared (preferably after substitution, to ensure uniformity) with the context terms associated with the ambiguous term, and the appropriate primary term selected on this basis. It should be appreciated that an ambiguous term, such as an abbreviation (eg “acc”), can never itself be a primary term, since it inherently lacks a single, primary, meaning.

In the comparison step 406, the ruleset 206 is searched, based upon comparison of the record description with rule descriptions, and the record type with source types, in an attempt to find a match. If an exact match is found (indicated by the decision block 408), then this is considered to be the “best match”, and returned by the output step 412. If no exact match is found, then the results of comparisons between the record description and relevant rule descriptions are ranked at step 410. The ranking is typically performed by associating a numerical “similarity” score with each rule in the ruleset 206, depending on the “closeness” of match with the record description. Various algorithms are available for assessing similarity of two text strings, such as the Levenshtein Edit Distance, and any suitable one of these known algorithms may be employed for this purpose. The most highly-ranked (ie most similar) rule is returned as the best match at step 412.

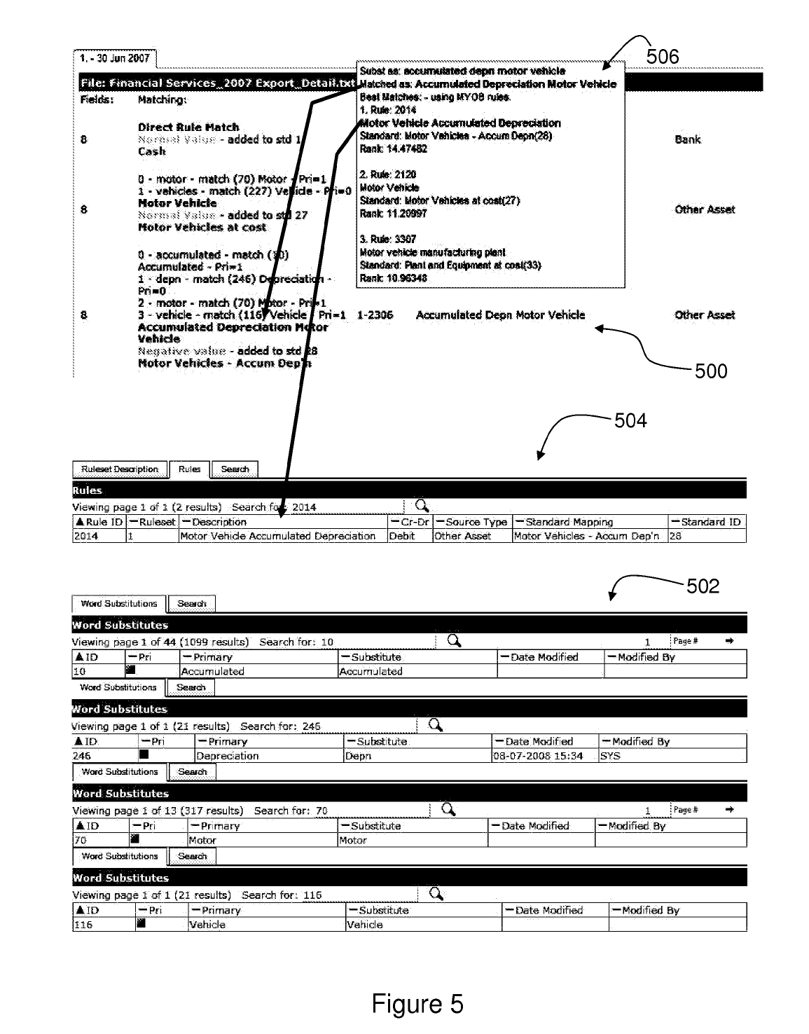

While the foregoing describes, in general terms, the operation of the preferred embodiment of the invention, a number of specific examples will now be described, with reference to FIGS. 5 to 11, in order to further illustrate preferred features and advantages of the invention, without limiting the additional features that may be provided. The illustrations in FIGS. 5 to 11 are screenshots taken from an Internet-based implementation of the invention, wherein the user interface shown is provided within a web browser window.

FIG. 5 shows a first example in which the record description associated with an input financial data record 500 is “Accumulated Depn Motor Vehicle”. As shown by the substitution table entries 502, the terms “accumulated”, “motor”, and “vehicle” are primary terms, that are not substituted. The term “depn” is a substitute term, which is replaced with the primary term “depreciation”. Accordingly, the pre-processed record description utilised in the comparison step 406 is “Accumulated Depreciation Motor Vehicle”. As shown in the ruleset entry 504, the closest match identified in the ruleset 206 is “Motor Vehicle Accumulated Depreciation”, which maps to a standard term “Motor Vehicles—Accum Dep'n” having standard ID 28 within the accounting standard 208. It is accordingly apparent that, despite the differences in the terminology appearing within the input financial data record 500, the record has been accurately matched and mapped to the relevant output financial data record.

FIG. 5 also shows the top three rankings 506 generated in the process of identifying a best match. As noted above, the most highly-ranked match was the rule having the description “Motor Vehicle Accumulated Depreciation”. The second- and third- (and clearly inferior) ranked matches were with rules having the descriptions “Motor Vehicle” (corresponding with the standard term “Motor Vehicles at cost”), and “Motor Vehicle Manufacturing Plant” (corresponding with the standard term “Plant and Equipment at cost”).

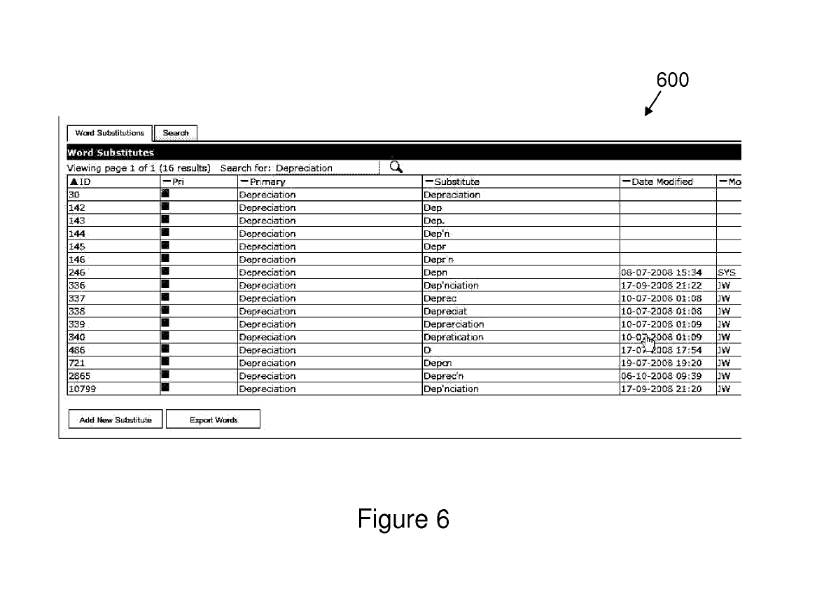

As noted in the above example, the term “depn” is substituted with the primary term “depreciation”, for the purposes of matching within the ruleset 206. In FIG. 6 there is shown an exemplary excerpt 600 from the full substitution table, illustrating a variety of variations that will also be mapped to the primary term “depreciation”. Careful construction of the substitution table thus enables a wide variety of terms and variations utilised by users of financial management and accounting software packages to be converted into a substantially smaller number of primary terms, thereby facilitating the construction and management of a manageable ruleset.

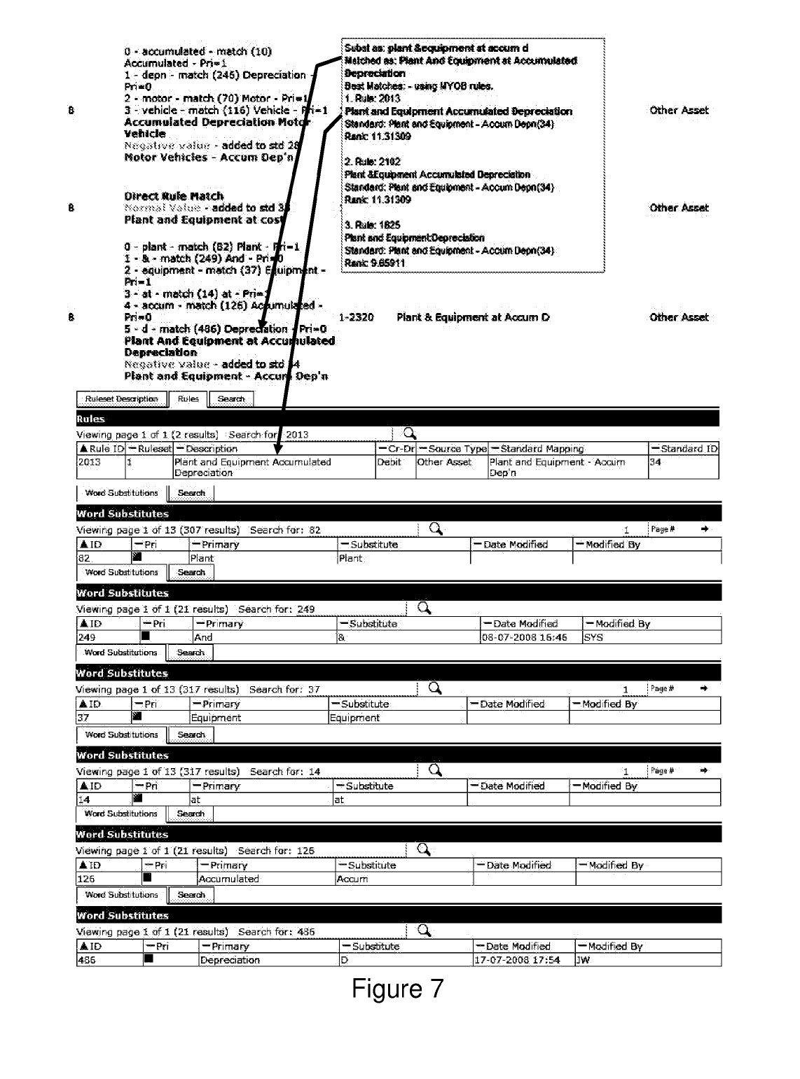

FIG. 7 shows a slightly more sophisticated example, in which the record description “Plant & Equipment at Accum D” is processed by substitution to form the description “Plant and Equipment at Accumulated Depreciation”, which is subsequently mapped to the standard term “Plant and Equipment—Accum Dep'n”.

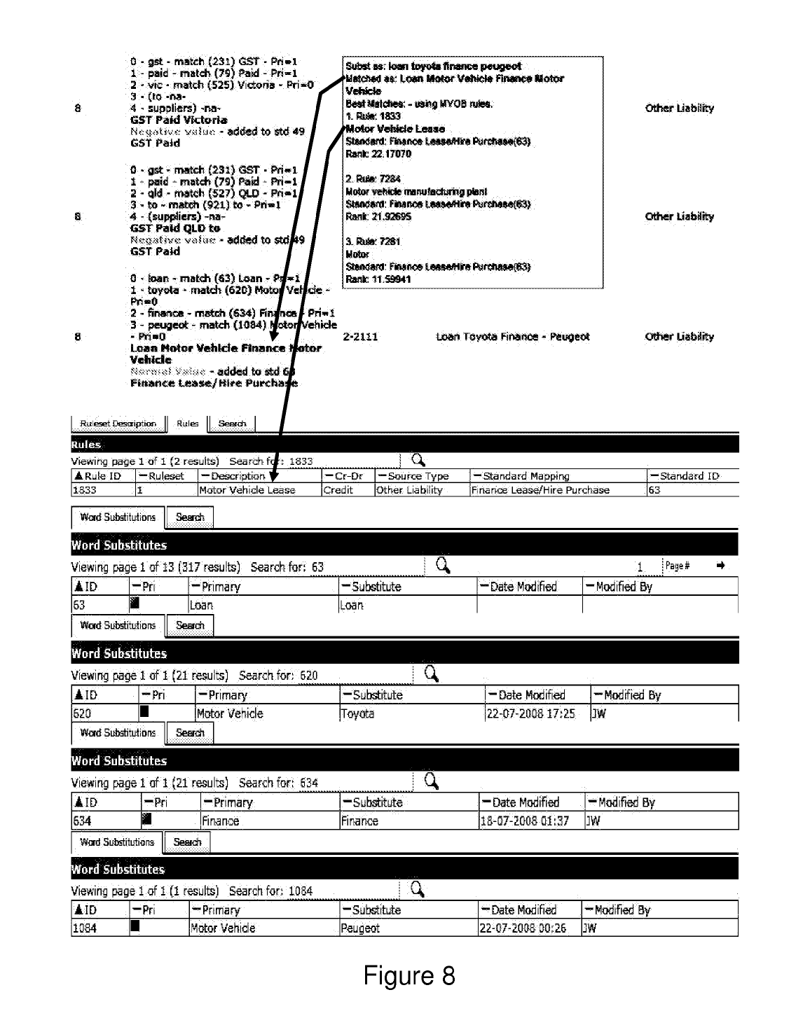

In FIG. 8 there is shown a further example, in which the record description “Loan Toyota Finance—Peugeot” is converted by substitution into the description-for-matching “Loan Motor Vehicle Finance Motor Vehicle”. It is noted in this case that the substitution table converts vehicle brand names into the generic term “motor vehicle”. The highest-ranked rule within the ruleset has the corresponding rule description “Motor Vehicle Lease” (and matching type “Other Liability”). This is then mapped to the standard term “Finance Lease/Hire Purchase”.

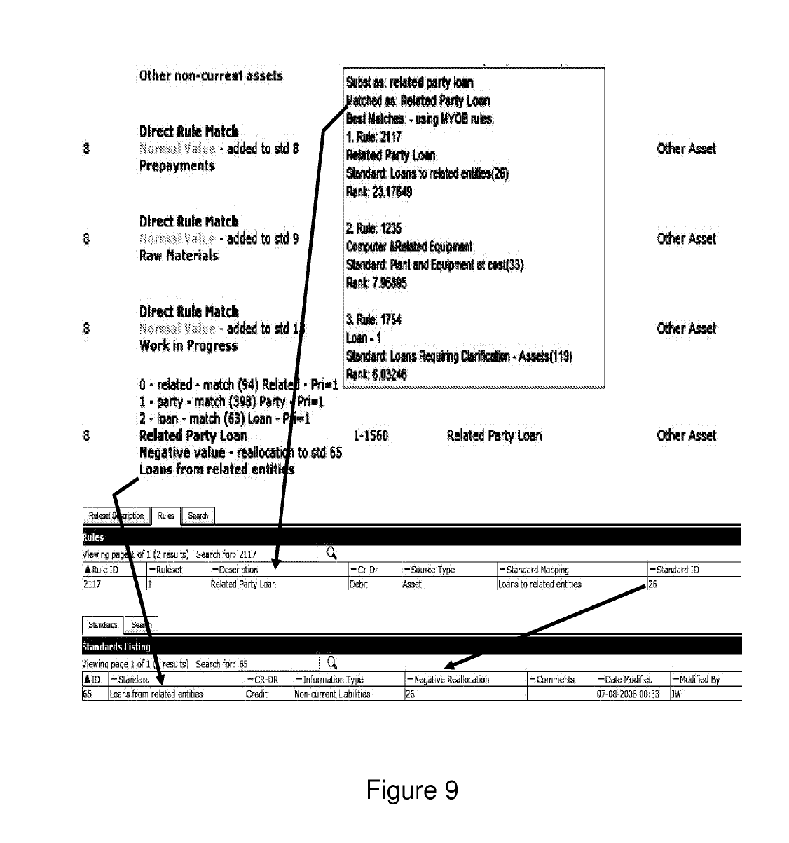

FIG. 9 shows a further example which illustrates a negative reallocation. In this case, the record description “Related Party Loan” (which consists only of primary terms) is initially matched to “Loans to Related Entities”, based upon its type of “Other Asset”. However, in this particular example, the financial value in the input data record is negative, and accordingly the “asset” is reallocated to its equivalent liability, “Loans from Related Entities”, and the output financial value reallocated to be positive.

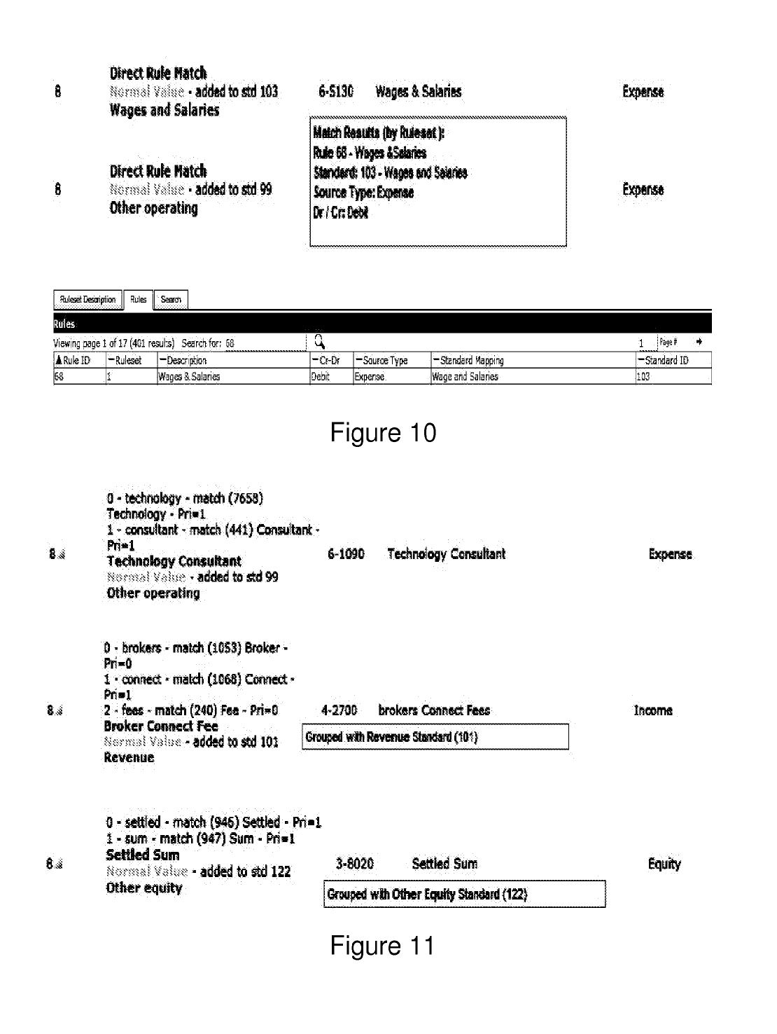

FIG. 10 illustrates a direct rule match. In particular, the input record description “Wages & Salaries” has a direct match to a rule description within the ruleset, corresponding with the standard term “Wages and Salaries”. Accordingly, in this example no ranking and selection of a “best match” is required, since a direct match is always the best match.

Finally, FIG. 11 illustrates three examples in which no viable match is found within the ruleset to the input financial data record description. In the preferred embodiment of the invention, when no direct match, or viable best match, is available, the accounting entry is allocated to a predetermined standard based upon the source type. Thus, for example, the record having description “Technology Consultant”, identified as an “expense” is allocated to the standard term “Other Operating”. The record having description “brokers Connect Fees” identified as “income”, is allocated to the standard term “Revenue”. Finally, the record having the description “Settled Sum”, identified as “equity”, is allocated to the standard term “Other Equity”.

It will be appreciated that once all of the input financial data records have been converted into output financial data records, in accordance with the accounting standard 208, each output record has a defined type and meaning in accordance with the accounting standard. In this form, it is possible to compile a uniform statement of financial information in accordance with any desired format. For example, the output data records may be compiled into a format suitable for use with a variety of widely-available software packages, such as a text-based format, a spreadsheet format (such as a Microsoft™ Excel™ document), a portable layout format (such as Adobe™ PDF), or the like. Alternatively, the output data records may be compiled into a document using an open encoding standard, such as Extensible Markup Language (XML), which may be particularly advantageous for transmission and/or access via the internet. In a further alternative, the output data records may be compiled into a proprietary format compatible with more-specialised financial analysis software packages, such as may be used by large financial institutions.

In particular, the output data records may be compiled into a form suitable for input into a financial analysis software package executed by the financial institution computer 106. As shown in the system 100 of FIG. 1, the preferred mechanism for processing and submission of financial data to a financial institution is via the Internet 102. Accordingly, an accountant or other end-user may submit financial statements, exported from a financial management or accounting package, from the user computer 104 to the server computer 108, as indicated by the arrow 120. Processing of the financial statements is performed by the server computer, in accordance with the methods described above, in order to compile a uniform statement of financial information including the generated output financial data records. The uniform statement is then transferred via the Internet 102 to the financial institution computer 106, as indicated by the arrow 122. This statement is suitable for input into the institution's financial analysis software, and accordingly the institution is able to process and approve (or deny) a request for credit, or other application, with a very low turnaround time, and at reduced cost, as compared with data entry by a human operator. The outcome of the application may be conveyed back to the accountant or customer either via the Internet 102, through the intermediary of the server computer 108, or by other means, such as telephone, in accordance with a predetermined operating procedure.

While the foregoing description has covered various exemplary features of a preferred embodiment of the invention, it will be appreciated that this is not intended to be exhaustive of all possible functions provided within various embodiments of the invention. It will be understood that many variations of the present invention are possible, and the overall scope is as defined in the claims appended hereto.

1. A computer-implemented method of generating a uniform statement of financial information from a plurality of input financial data records, wherein each input financial data record includes at least a record description and an input financial value, the method including the steps of:
providing an accounting standard which includes a plurality of predetermined standard terms, each of which is associated with one of a plurality of predetermined standard types;
providing at least one ruleset associated with the input financial records, the ruleset including a plurality of rules, wherein each rule includes at least a rule description, and an associated mapping to one of the standard terms of the accounting standard;
generating a plurality of output financial data records by, for each one of said input financial data records:
determining a best-match rule for the financial data record amongst the rules in the ruleset, by comparing at least the record description with the rule descriptions of rules within the ruleset; and
generating an output financial data record including a standard description corresponding with the standard term associated with the best-match rule, and an output financial value corresponding with the input financial value,
and compiling a uniform statement of financial information including said plurality of output financial data records.

2. The method of claim 1 wherein each input financial data record includes an associated input record type, and each rule in the ruleset further includes a corresponding type indication, whereby the step of determining a best-match rule includes comparing the record description with the rule description only of rules in the ruleset for which the type indication is compatible with the input record type.

3. The method of claim 2 wherein the ruleset corresponds with a source software application used to record, maintain and/or generate the input financial data records.

4. The method of claim 2 wherein the step of determining a best-match rule amongst the rules in the ruleset includes pre-processing the record description to facilitate comparison with the rule descriptions in the ruleset.

5. The method of claim 4 wherein said pre-processing includes substitution of terms appearing within the record description.

6. The method of claim 5 wherein said substitution includes context-sensitive substitution of ambiguous terms appearing within the record description, whereby a choice of a substitute term is based upon other elements of the input financial data record.

7. The method of claim 2 wherein the best match may be a direct match between the record description and a rule within the ruleset.

8. The method of claim 7 wherein, in the event that no direct match exists, a number of candidate matches is generated and ranked, in accordance with an appropriate ranking algorithm.

9. The method of claim 2 including a further step of processing at least the input financial value in order to derive a corresponding modified output financial value.

10. The method of claim 9 wherein the modified output financial value is a numerical negative of the input financial value.

11. The method of claim 10 wherein the step of processing at least the input financial value includes performing a corresponding reallocation of the standard term and/or description of the output financial value.

12. The method of claim 2 wherein the step of compiling a uniform statement of financial information includes grouping the output financial data records in accordance with associated standard types within the accounting standard.

13. The method of claim 2 wherein, in the step of compiling, totals and/or summaries of financial information are generated, and/or additional ratios or other metrics calculated, in accordance with a required format of the uniform statement of financial information.

14. The method of claim 2 wherein the format of the uniform statement of financial information corresponds with a required format of a destination financial software package.

15. A computer-implemented apparatus for generating a uniform statement of financial information from a plurality of input financial data records, wherein each input financial data record includes at least a record description and an associated input financial value, the apparatus including:
a data store containing an accounting standard which includes a plurality of predetermined standard terms, each of which is associated with one of a plurality of predetermined standard types;
a data store containing at least one ruleset associated with the input financial records, the ruleset including a plurality of rules, wherein each rule includes at least a rule description, and an associated mapping to one of the standard terms of the accounting standard;
computer-software-implemented means for generating a plurality of output financial data records by, for each one of said input financial data records, providing computer-software-implemented means for:
determining a best-match rule for the financial data record amongst the rules in the ruleset by comparing at least the record description with the rule descriptions of rules within the ruleset; and
generating an output financial data record including a standard description corresponding with the standard term associated with the best-match rule, and an output financial value corresponding with the input financial value,
computer-software-implemented means for compiling a uniform statement of financial information including said plurality of output financial data records; and
computer-software-implemented means for outputting the uniform statement of financial information.

16. The apparatus of claim 15 further including at least one input/output peripheral interface arranged to receive the input data records and to output the uniform statement of financial information.

17. The apparatus of claim 16 wherein the input/output peripheral interface includes a network interface.

18. The apparatus of claim 17 which includes an Internet server configured to receive input data records, and to output the uniform statement of financial information, over the Internet via said network interface.

19. The apparatus of claim 18 which is configured to provide a secure web-based service.

20. A system for generating a uniform statement of financial information, the system including:
a microprocessor;
at least one memory device, operatively coupled to the microprocessor, which includes one or more data stores containing
an accounting standard which includes a plurality of predetermined standard terms, each of which is associated with one of a plurality of predetermined standard types, and
at least one ruleset associated with the input financial records, the ruleset including a plurality of rules, wherein each rule includes at least a rule description, and an associated mapping to one of the standard terms of the accounting standard; and
at least one input/output peripheral interface, operatively coupled to the microprocessor,
wherein the memory device further contains executable instruction code, which, when executed by the microprocessor causes the system to implement a method including the steps of:
receiving, via the input/output peripheral interface, a plurality of input financial data records, wherein each input financial data record includes at least a record description and an associated input financial value
generating a plurality of output financial data records by, for each one of said input financial data records:
determining a best-match rule for the financial data record amongst the rules in the ruleset, by comparing at least the record description with the rule descriptions of rules within the ruleset; and
generating an output financial data record including a standard description corresponding with the standard term associated with the best-match rule, and an output financial value corresponding with the input financial value,
compiling a uniform statement of financial information including said plurality of output financial data records; and
outputting the uniform statement of financial information via the input/output peripheral interface.

21. The system of claim 20 wherein the one or more data stores further contain a substitution table which includes a plurality of primary terms each of which is associated with one or more substitute terms, and the executable instruction code implementing the step of determining a best-match rule amongst the rules in the ruleset includes instructions for pre-processing the record description to identify and replace substitute terms with corresponding primary terms in the substitution table to facilitate comparison with the rule descriptions in the ruleset.

22. The system of claim 20 wherein the one or more data stores further contain a disambiguation table which includes a plurality of potentially ambiguous terms each of which is associated with one or more context terms, and the executable instruction code implementing the step of determining a best-match rule amongst the rules in the ruleset includes instructions for pre-processing the record description to identify ambiguous terms and to compare other terms appearing within the record description with corresponding context terms in order to select a single, unambiguous, primary term.

23. The system of claim 20 wherein the executable instruction code implementing the step of determining a best-match rule amongst the rules in the ruleset includes instructions for selecting the best match as a direct match between the record description and a rule within the ruleset.

24. The system of claim 23 wherein the executable instruction code implementing the step of determining a best-match rule amongst the rules in the ruleset includes instructions for, in the event that no direct match exists, generating and ranking a number of candidate matches in accordance with an appropriate ranking algorithm.

25. The system of claim 20 wherein the at least one input/output peripheral interface includes a network interface operatively in communication with the Internet, and the executable instruction code includes instructions which, when executed by the microprocessor, cause the system to provide a secure web-based service via the network interface arranged to receive input financial data records, and to transmit a corresponding uniform statement of financial information, via the internet
